(19) United States
(12) Patent Application Publication
(10) Pub. No.: US 2024/0178476 A1
(43) Pub. Date: May 30, 2024

(54) Cooling Device for an Electrical Energy Store Having Gravity-Assisted Heat Pipes, Electrical Energy Store, and Motor Vehicle

(71) Applicant: Bayerische Motoren Werke Aktiengesellschaft, Muenchen (DE)

(72) Inventor: Torsten FRANKE, Muenchen (DE)

(21) Appl. No.: 18/282,579

(22) PCT Filed: Mar. 1, 2022
(86) PCT No.: PCT/EP2022/055036

§ 371 Date: Sep. 18, 2023

(30) Foreign Application Priority Data
Mar. 29, 2021 (DE) 10 2021 107 822.9

(51) Int. Cl. H01M 10/6552; H01M 10/613; H01M 10/625; H01M 50/216; H01M 50/224; H01M 50/242; H01M 50/249; B60L 50/60

(52) U.S. Cl. CPC H01M 10/6552; H01M 10/613; H01M 10/625; H01M 50/216; H01M 50/224; H01M 50/242; H01M 50/249; B60L 50/60; H01M 2220/20

(57) ABSTRACT

A cooling device for an electrical energy store for cooling energy storage cells of the electrical energy store, the cooling device comprising gravity-assisted heat pipes having a working medium for absorbing waste heat of the energy storage cells, and a frame having walls for forming receptacles for the energy storage cells, wherein the gravity-assisted heat pipes are integrated into the walls.

### FIELD

The invention relates to a cooling device for an electrical energy store for cooling energy storage cells of the electrical energy store, wherein the cooling device comprises gravity heat pipes with a working medium for taking up waste heat from the energy storage cells. The invention moreover relates to an electrical energy store and to a motor vehicle.

### BACKGROUND AND SUMMARY

In the present case, interest is directed to electrical energy stores which can be used, for example, as traction batteries for electrified motor vehicles, that is to say electric or hybrid vehicles. Such electrical energy stores usually have at least one cell assembly of multiple energy storage cells. Cooling devices are used to cool the energy storage cells during operation of the electrical energy store. Such cooling devices may for example, as disclosed in WO 2020/207718 A1, comprise gravity heat pipes.

An object of the present invention is to provide a solution for how gravity heat pipes can be integrated easily into an electrical energy store.

This object is achieved according to the invention by a cooling device, an electrical energy store and a motor vehicle having the features according to the respective independent patent claims. The dependent patent claims, the description and the figures relate to advantageous embodiments of the invention.

A cooling device according to the invention for an electrical energy store serves to cool energy storage cells of the electrical energy store. The cooling device comprises gravity heat pipes with a working medium for taking up waste heat from the energy storage cells. Furthermore, the cooling device comprises a frame with walls for forming receptacles for the energy storage cells, wherein the gravity heat pipes are integrated in the walls.

Also part of the invention is an electrical energy store with at least one cell assembly of energy storage cells and a cooling device according to the invention, wherein the energy storage cells are disposed in the receptacles in the frame, and with a store housing, in which the cell assembly is disposed. The electrical energy store may, for example, be a high-voltage energy store which is used as rechargeable traction battery or as traction accumulator for an electrically operable motor vehicle. The electrical energy store has the at least one cell assembly, which comprises multiple energy storage cells. The energy storage cells may, for example, be in the form of prismatic energy storage cells or pouch cells. The energy storage cells are preferably in the form of round cells. The energy storage cells have cell terminals, or cell poles, which may be disposed in the region of a cell housing cover of a cell housing of the energy storage cells. The cell housing moreover has cell housing side walls and a cell housing bottom.

The store housing may comprise housing parts in the form of a housing cover, or a housing upper part, and a housing bottom, or a housing lower part, which are joined together to form a housing interior space. The at least one cell assembly is disposed in the housing interior space. To cool the energy storage cells, the at least one cell assembly moreover comprises the cooling device. The cooling device comprises the gravity heat pipes. Gravity heat pipes, or two-phase thermosiphons, are heat exchangers which transport the waste heat by way of heat of evaporation. To that end, the gravity heat pipes have an elongate sleeve which extends in a vertical direction along the direction of gravity. In the sleeve, there is a working medium which is in a liquid state as long as the temperature, caused by the waste heat, of the energy storage cells is below a boiling point of the liquid working medium. As soon as the temperature exceeds the boiling point, the working medium evaporates. In other words, the working medium transitions from the liquid state to the gaseous state. The working medium rises upward counter to the direction of gravity in the form of vapor, condensates there on a heat sink, coupled to the gravity heat pipe, of the cooling device and thus discharges the transported waste heat to the heat sink. As a result, the working medium transitions from the gaseous state to the liquid state again and falls back downward in the form of liquid droplets as a result of the gravitational force. The return transport of the condensed working medium is thus effected by the gravitational force. The heat sink is in particular formed by a housing part of the store housing in the form of the housing upper part.

These gravity heat pipes are integrated in the frame, which is designed to hold the energy storage cells. To this end, the frame has walls which form the receptacles for the energy storage cells. In the case of energy storage cells in the form of round cells, these receptacles may for example be in the form of cavities with a round or honeycomb-shaped cross section. The energy storage cells are pushed in these receptacles, with the result that the walls extend in the vertical direction along the cell housing side walls. The gravity heat pipes are integrated in these walls. The gravity heat pipes are thus adjacent to the energy storage cells and extend between the energy storage cells along the cell housing side walls. In this case, the frame is made from a material with good thermal conductivity, for example aluminum or magnesium. For example, the frame may be produced by die casting. To electrically insulate the energy storage cells from the frame, an insulating element, for example in the form of a plastics heat-shrinkable sleeve, may be disposed between the cell housings of the energy storage cells and the walls of the frame. The energy storage cells can thus discharge the waste heat via the walls, which have good thermal conductivity, to the gravity heat pipes, from where it is transported to the heat sink.

By integrating the gravity heat pipes in the frame, the gravity heat pipes can be integrated in the electrical energy store with particular ease and saving of space.

Preferably, the frame is additionally designed to take up forces caused by an accident. The frame thus protects the energy storage cells against an action of force. The frame can moreover comprise crash structures. The crash structures may be disposed in a frame region which faces toward the front of the vehicle, in a frame region which faces toward the rear of the vehicle, or in lateral frame regions which extend along a vehicle longitudinal axis. The crash structures may for example be in the form of shear panels and/or honeycomb structures.

It has proven to be advantageous when the walls have tubular cavities which are filled with the working medium to form the gravity heat pipes. The gravity heat pipes are thus formed by the frame itself, in that the cavities are made in the walls in the form of elongate channels and are filled with the working medium. The cavities may be open on one side, for example on an upper side of the frame. The upper side of the frame may be fastened sealingly to the housing upper part, with the result that the gravity heat pipes are thermally connected to the housing upper part.

In an advantageous development of the electrical energy store, it comprises a support and a cell contact-connection system for interconnecting the energy storage cells, wherein the cell contact-connection system and the frame are integrated in the support. The cell contact-connection system is in particular in the form of a punched comb with a conductor track pattern which enables predetermined interconnection of the energy storage cells. This punched comb is manufactured by providing a conductor material, for example a metal sheet, with a structure and making cutouts in the conductor material in a first step. In a second step, the structured conductor material and the frame are connected to the support. The conductor material and the frame can be connected to the support, for example, by joining them by means of primary forming. To this end, the structured conductor material and the frame are encapsulated with an insulating material by injection molding and/or potted with an insulating material. In the course of encapsulation by injection molding or potting, certain regions of the conductor material can be left free in order to finish the punched comb in a third step. To this end, further cutouts can be made in the conductor material to produce a predetermined conductor track pattern.

Also part of the invention is a motor vehicle having at least one electrical energy store according to the invention. The motor vehicle is in particular an electrified motor vehicle and comprises the electrical energy store as traction battery. In particular, the frame of the electrical energy store is connected to the bodywork of the motor vehicle with formation of a support structure.

The embodiments presented in relation to the cooling device according to the invention and their advantages apply correspondingly to the electrical energy store according to the invention and to the motor vehicle according to the invention.

Further features of the invention will become apparent from the claims, the figures and the description of the figures. The features and combinations of features that are mentioned in the description above and the features and combinations of features that are mentioned in the description of the figures below and/or are shown in the figures alone can be used not just in each specified combination but also in other combinations or individually.

The invention will now be explained in more detail on the basis of a preferred exemplary embodiment and with reference to the drawings.

### BRIEF DESCRIPTION OF THE DRAWINGS

FIG. 1 shows a schematic illustration of an electrical energy store;

FIG. 2 shows a schematic sectional illustration of a first embodiment of an electrical energy store in a first plane;

FIG. 3 shows a schematic sectional illustration of the first embodiment of an electrical energy store in the second plane;

FIG. 4 shows a schematic sectional illustration of a second embodiment of an electrical energy store in the first plane;

FIG. 5 shows a schematic sectional illustration of the second embodiment of an electrical energy store in the second plane; and

FIG. 6 shows a schematic sectional illustration of an embodiment of an electrical energy store in a third plane.

### DETAILED DESCRIPTION

In the figures, elements that are the same or have the same function are provided with the same reference signs.

FIG. 1 shows an electrical energy store EES, which comprises a store housing 1 with a first housing part 2a in the form of a housing lower part and a second housing part 2b in the form of a housing upper part. The electrical energy store EES may for example be used as traction battery for an electrically operable motor vehicle and be in the form of a high-voltage energy store. The housing upper part 2b may have a double-walled form and contain an interspace 3 for a flowing cooling fluid. The interspace 3 may be connected to an external cooling circuit via connections. A cell assembly 4 is disposed in the store housing 1 between the housing lower part 2a and the housing upper part 2b.

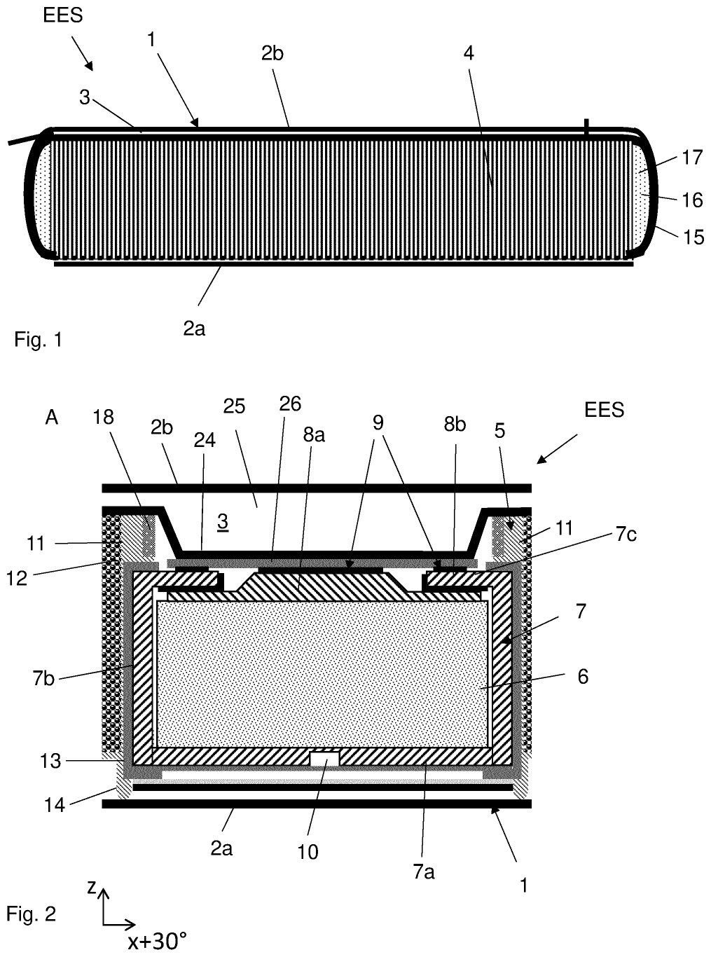

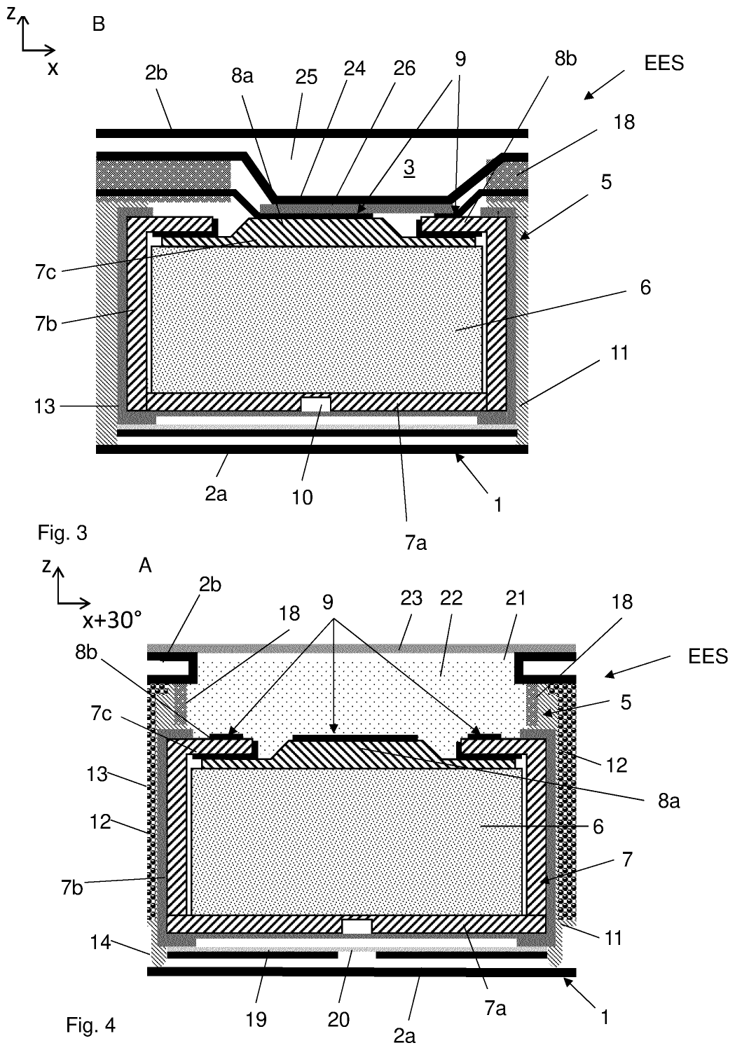

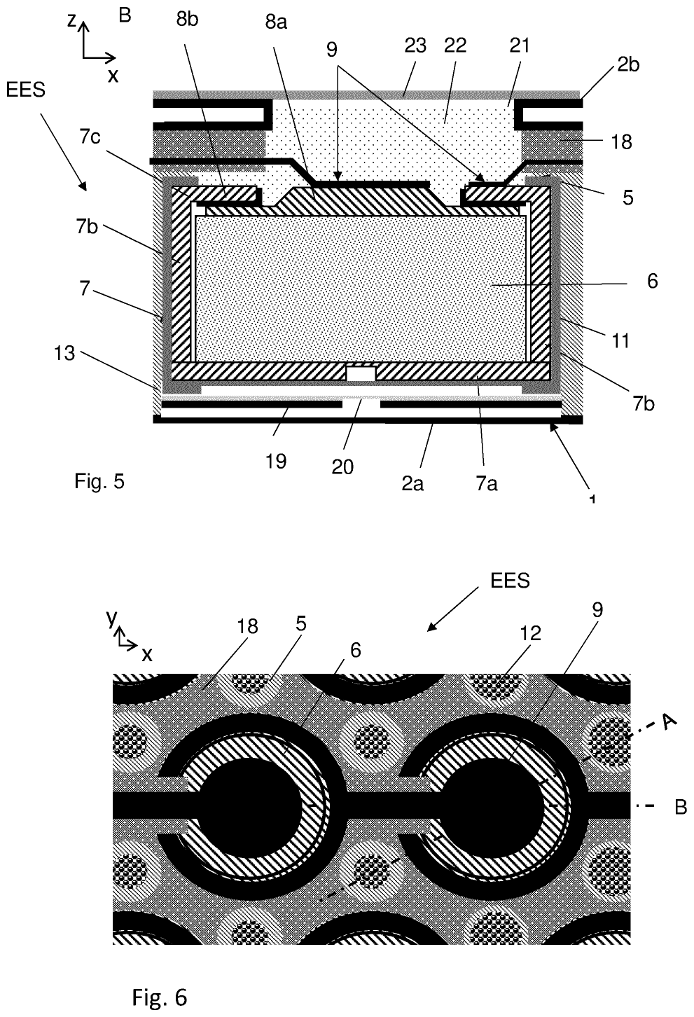

As shown in the exemplary embodiments of the electrical energy store EES according to FIG. 2 to FIG. 5, the cell assembly 4 comprises a frame 5 and energy storage cells 6. Here, the electrical energy store EES according to FIG. 2 to FIG. 5 is illustrated in a sectional illustration in a z-x plane (B) and in a section (A) which deviates from x by 30°. The x direction corresponds for example to a (vehicle) transverse direction and the z plane corresponds for example to a (vehicle) vertical direction. FIG. 6 shows a sectional illustration of an electrical energy store EES in an x-y plane. The y direction corresponds for example to a (vehicle) longitudinal direction. The embodiments of the electrical energy store EES according to FIG. 2 and FIG. 4 correspond to a section along the sectional line A shown in FIG. 6. The same embodiments of the electrical energy store EES according to FIG. 3 and FIG. 5 correspond to a section along the sectional line B shown in FIG. 6.

The energy storage cells 6 each have a cell housing 7, which comprises a cell housing bottom 7a, cell housing side walls 7b and a cell housing cover 7c. The energy storage cells 6 may be for example round cells, such that the cell housing cover 7c and the cell housing bottom 7a are circular and the cell housing side walls 7b are cylindrical. The cell housing side walls 7b extend in the vertical direction z. The cell housing cover 7c may have cell terminals 8a, 8b or cell poles, which are isolated from one another and can be electrically connected to interconnect the energy storage cells 6 by means of a cell contact-connection system 9. The energy storage cells 6 can moreover have degassing openings 10 for egress of a hot gas in the event of a fault, for example in the event of a short circuit internal to the cell. In an exemplary embodiment, the housing lower part 2a of the store housing 2 is spaced apart from the degassing openings 10 or is in the form of an expandable heat shield to form a cooling space for hot gas.

The frame 5 has walls 11, which form receptacles for the energy storage cells 6 and which extend along the vertical direction z at least partially over a height of the cell housing side walls 7b. The walls 11 can take up the waste heat discharged by the energy storage cells 6 and conduct it in the direction of the housing upper part 2b. In the process, the transport of heat out of the energy storage cells 6 in the direction of the housing upper part 2b is assisted by gravity heat pipes 12, which are only shown in the illustrations according to FIG. 2 and FIG. 3 owing to the sectional line A, which comprises the gravity heat pipes 12. Here, the gravity heat pipes 12 are integrated monolithically in the frame 5 or joined to the frame 5 as one or more separate components. The gravity heat pipes 12 likewise extend in the vertical direction z along the cell housing side walls 7b and are disposed between the energy storage cells 6. The frame 5 is connected, for example by adhesive bonding, screwing, riveting, clinching, soldering or welding, to the housing upper part 2b in a heat-conducting manner. The gravity heat pipes 12 have a working medium, for example a liquid, which evaporates as a result of the waste heat from the energy storage cells 6 and in the process transports the exhaust heat upward in the vertical direction z counter to the direction of gravity. The gravity heat pipes 12 are thermally coupled to the housing upper part 2b, which forms a heat sink or a condenser. The gravity heat pipes 12 may be upwardly open and connected directly to the housing upper part 2b. The gravity heat pipes 12 are downwardly closed by the walls 11 of the frame 5. The evaporated working medium condenses again on the housing upper part 2b with discharge of the exhaust heat to the housing upper part 2b and falls back downward counter to the vertical direction z as a result of gravity, where it can evaporate again for renewed take-up of exhaust heat.

The working range of the gravity heat pipes 12 is adapted to the permissible temperature range of the energy storage cells 6 and the control of the heat flow by the nature of the filling, a filling pressure, or a variation in shape and dimensions over their length. In a particularly advantageous calibration of the gravity heat pipes 12, they make a significant contribution to the transport of heat in the intended operating range of the electrical energy store EES and dry out in the event of excessive thermal load, in order to shield the surroundings of a degassing energy storage cell 6 from the thermal load of the degassing energy storage cell 6.

The energy storage cells 6 are electrically insulated from the housing lower part 2a, the housing upper part 2b and the frame 5. In an exemplary embodiment, the energy storage cells 6 have electrical insulation 13 with respect to the frame 5, for example in the form of a heat-shrunk plastics sleeve. The energy storage cells 6 are each inserted sealingly in the frame 5 at least in the region of the cell contact-connection system 9 and fixed for example by latching elements 14 of the frame 5.

Contact surfaces of the cell contact-connection system 9 are connected metallurgically or by pressure to the associated cell terminals 8a, 8b of the energy storage cells 6. According to FIG. 2 and FIG. 3, on an inner side 24 facing toward the cell assembly 4, the housing upper part 2b to this end has at least one anvil-like bulge 25, which presses the contact surfaces of the cell contact-connection system 9 against the cell terminals 8a, 8b. The housing upper part 2b is thus integrated in the force fit of the pressure-contact system of the cell contact-connection system 9. An insulating layer 26 is disposed between the inner side 24 of the housing upper part 2b and the cell terminal 8a, 8b at least in the region of the bulge 25. This embodiment enables additional cooling, on the contact-connection side, of the energy storage cells 6.

In an advantageous embodiment, the frame 5, as shown in FIG. 1, has a lateral delimitation 15 of the electrical energy store EES and a space 16 for a filler 17 which provides hydraulic compensation in the event of external forces. Moreover, the frame 5 comprises elements for mechanical integration in a motor vehicle and can be used as load-bearing structural component of a bodywork of the motor vehicle, for example as floor assembly. Properties such as manufacturability, mountability, heat conduction, ability to take up forces and weight can be optimized by a material selection, recesses, adaptation of wall thicknesses and rib structures.

For example, the frame 5 is made from aluminum or magnesium in a casting method or in the form of a 3D print. A frame 5 manufactured by means of magnesium can be cast particularly well, has particularly favorable demolding slopes, and has a particularly weight-saving form. The cell contact-connection system 9 is in the form for example of a leadframe or punched comb. The frame 5 and the cell contact-connection system 9 are connected to one another by a joining process, for example by potting. In the process, the frame 5 can also be integrated in a monolithic component within a step for manufacturing an electrically insulating support 18 of the cell contact-connection system 9 by casting, or the monolithic component can be in the form of a 3D print.

To protect the energy storage cells 6 from hot gas, it is possible, as shown in FIG. 2 to FIG. 5, to attach an additional cell covering 19, which may additionally provide sealing, detaches from the frame 5 in the event of excess pressure, and opens up a path for the hot gas or/and contains a rupture element 20 for passage of the hot gas, to the frame 5 on the cell housing bottom. In the event of servicing, in the case of the arrangement shown in FIG. 2 and FIG. 3, it is possible to dispense with direct access to the cell contact-connection system 9 and perform the servicing exclusively by taking off the housing lower part 2a and removing the cell covering 19 and the energy storage cell 6. It is particularly advantageous here when the servicing can be carried out with high specificity and direct accessibility from the underbody of the motor vehicle. As an alternative to the cell covering 19 or in addition, the cell housing bottom 7a may also be coated with a fire-protection lacquer.

In an embodiment of the electrical energy store according to FIG. 4 and FIG. 5, the housing upper part 2b may be interrupted in the region of the energy storage cells 6 by means of cutouts 21, in order to ensure metallurgical contact-connection of the energy storage cells 6 and the introduction of a potting 22. The cutouts 21 are lastly provided with a contact covering 23. In the event of servicing, the contact covering 23 can be at least locally removed and lastly closed by a patch.

1-10. (canceled)

11. A cooling device for an electrical energy store for cooling energy storage cells of the electrical energy store, the cooling device comprising:
gravity heat pipes with a working medium for taking up waste heat from the energy storage cells; and
a frame with walls forming receptacles for the energy storage cells, wherein the gravity heat pipes are integrated in the walls.

12. The cooling device according to claim 11,
wherein the frame is configured to take up forces caused by an accident.

13. The cooling device according to claim 11,
wherein the walls comprise tubular cavities that are filled with the working medium to form the gravity heat pipes.

14. The cooling device according to claim 11,
wherein the cooling device comprises a heat sink, on which evaporated working medium transporting the exhaust heat condenses to discharge the exhaust heat.

15. The cooling device according to claim 14,
wherein the heat sink comprises a housing part of a store housing of the electrical energy store.

16. The cooling device according to claim 11,
wherein the frame comprises die cast aluminum or die cast magnesium.

17. An electrical energy store comprising:
at least one cell assembly comprising energy storage cells;
the cooling device according to claim 11, wherein the energy storage cells are disposed in the receptacles in the frame; and
a store housing, in which the at least one cell assembly is disposed.

18. The electrical energy store according to claim 17,
wherein the electrical energy store comprises:
a support; and
a cell contact-connection system configured to interconnect the energy storage cells, wherein the cell contact-connection system and the frame are integrated in the support.

19. A motor vehicle comprising:
the electrical energy store according to claim 17.

20. The motor vehicle according to claim 19,
wherein the frame is connected to a bodywork of the motor vehicle with formation of a support structure.
